(19) United States
(12) Patent Application Publication
(10) Pub. No.: US 2024/0120764 A1
(43) Pub. Date: Apr. 11, 2024

(54) Device for charging battery packs

(71) Applicant: Andreas Stihl AG & Co. KG, Waiblingen (DE)

(72) Inventors: Thomas Heinrich, Leutenbach (DE); Daniel Sauerteig, Kernen im Remstal (DE); Leonard Mattheis, Waiblingen (DE)

(73) Assignee: Andreas Stihl AG & Co. KG, Waiblingen (DE)

(21) Appl. No.: 18/376,813

(22) Filed: Oct. 4, 2023

(30) Foreign Application Priority Data
Oct. 6, 2022 (EP) 22200131

(51) Int. Cl. H02J 7/00

(52) U.S. Cl. CPC H02J 7/007182; H02J 7/0019; H02J 7/0045

(57) ABSTRACT

A device for charging a battery pack includes a first battery compartment for a first battery pack and at least one second battery compartment for a further battery pack. The device is connected to a service voltage via a power supply unit. A voltage regulator is connected to the power supply and has a power output connected to the battery compartment. To charge battery packs with different performance data in a battery compartment, a first voltage regulator with a first power output for a first maximum charging current and at least one second voltage regulator having a second power output a second maximum charging current are provided. A switch arrangement is provided, which is designed to selectively connect the power output of a voltage regulator to only one battery compartment or the power outputs of at least two voltage regulators can be connected to just one battery compartment.

### CROSS-REFERENCE TO RELATED APPLICATION

This application claims the benefit of European Patent Application EP 22200131, filed on Oct. 6, 2022, the contents of which is incorporated in its entirety.

### BACKGROUND

Battery packs are used to power handheld devices, for example power tools. In practice, battery packs with different performance data are used. Individual battery packs can provide voltages of, for example, 12 V, 18 V or 24 V. Battery packs configured in such different ways are charged with different charging currents. A device for charging a battery pack must therefore be able to provide the required charging currents. However, in a charging station with a charging current of 24 A, for example, a battery pack with a maximum permissible charging current of 12 A cannot be readily charged.

### SUMMARY

The invention relates to a device for charging a battery pack with a first battery compartment for accommodating a first battery pack and at least a second battery compartment for accommodating a further battery pack.

The device is connected via a power supply to an electrical grid with a service voltage of, for example, 120 V. At least one voltage regulator is arranged between the power supply and a battery compartment, the power output of which is connected to a battery compartment. A charging voltage and a charging current are supplied to the battery compartment via the power output of the voltage regulator.

The device works with battery packs of different capacities and/or with different charging currents that can be charged in one and the same battery compartment.

This is made possible by a first voltage regulator with a first power output for a first maximum charging current that is provided between the power supply and the battery compartment while a second voltage regulator with a second power output for a second maximum charging current is provided between the power supply unit and the battery compartment. The power outputs of the voltage regulators are connected to the battery compartments via a switch arrangement. The switch arrangement is designed in such a way that it can switch the power output of one voltage regulator to only one battery compartment or connect both power outputs of both voltage regulators to just one battery compartment.

If a power output of a voltage regulator delivers a maximum charging current I₁ and the power output of another voltage regulator provides a maximum charging current I₂, a charging current I₁ or a charging current I₂ can be supplied to a respective battery compartment via the switch arrangement. Using the switch arrangement, it is also possible to switch the power outputs of both voltage regulators to just one battery compartment, so that a maximum charging current of I₁ plus I₂ is then available at the one battery compartment. A battery pack with a maximum charging current of, for example, 12 A or a battery pack with a higher charging current of, for example, 24 A can be charged in one and the same battery compartment.

The switch arrangement includes several switches in order to selectively connect the power outputs of the voltage regulators as described. The switch arrangement can thus comprise a first switch that selectively connects the power output of the first voltage regulator to the first battery compartment. The switch arrangement can further comprise a second switch that selectively connects the power output of the second voltage regulator to the second battery compartment. The power output of the first voltage regulator and the power output of the second voltage regulator can be selectively connected to one another via a third switch of the switch arrangement. That makes it possible to connect the power outputs of both voltage regulators together to only one battery compartment, for example the first or the second battery compartment.

In a further embodiment, the switch arrangement is connected to a control unit. The control unit is designed to operate the switches of the switch arrangement. For this purpose, the control unit advantageously processes information that is entered by a user, for example using a button. In a special embodiment, the control unit is connected to the battery compartments of the device via a communication connection. The communication connection is designed in such a way that it transmits the characteristics of a battery pack inserted into a battery compartment to the control unit. This relieves the user of having to tell the device which type of battery pack has been inserted. The control unit processes the data of the inserted battery pack transmitted via the communication connection and recognizes whether it can be charged with a simple charging current or with an increased charging current. If the battery pack can be charged with only a simple charging current, the control unit controls the switch arrangement in such a way that the battery compartment is connected to the battery pack with only one power output of a voltage regulator. However, if the control unit detects that the inserted battery pack can be charged with an increased charging current, the switches of the switch arrangement are actuated in such a way that two power outputs of the voltage regulators are connected together to the battery compartment with the battery pack. The user therefore only has to insert the battery pack into the battery compartment, whereupon the device independently sets a permissible maximum charging current based on the data from the battery pack by connecting only one power output of a voltage regulator or by connecting both power outputs of both voltage regulators to the battery compartment.

The device for charging a battery pack can include two, three, four or more battery compartments. The device may be designed in such a way that a voltage regulator is assigned to each battery compartment. This voltage regulator is connected to the associated battery compartment via a switch of the switch arrangement. For example, if four battery compartments are provided, the device includes four voltage regulators. The power outputs of at least two voltage regulators can be selectively connected to one another via a further switch of the switch arrangement. This ensures that two power outputs of the voltage regulators can be connected to at least one of the four battery compartments. At least this one battery compartment can then be operated—controlled by the switch arrangement—with the maximum charging current of a voltage regulator or with the sum of the maximum charging currents of two voltage regulators.

In order to keep the structure of the device for charging a battery pack simple, it is provided that the voltage regulators of the device are designed in the same way. In particular, the voltage regulators provided in the device have the same maximum charging currents. In this way, a battery compartment can be operated with the integer multiple of a maximum charging current. It is so possible, if the switch arrangement is designed in such a way, that three or four power outputs can be switched to just one battery compartment.

Several voltage regulators, which are designed in particular as step-down converters, are electrically connected parallel to one another in line branches. The voltage regulators are expediently fed on the input side from one or more power supplies and are connected to the battery compartments on the output side via the switch arrangement.

Further features of the invention result from the further claims, the description and the drawing. The features specified in the claims as well as the features listed in the description and the features shown in the drawing can be combined with one another.

### BRIEF DESCRIPTION OF THE DRAWINGS

FIG. 1 is a schematic block diagram of a device for charging battery packs with two battery compartments and a switch arrangement between the power output of the voltage regulators and the battery compartments.

FIG. 2 is a schematic block diagram corresponding to the illustration in FIG. 1 with an alternatively designed switch arrangement.

FIG. 3 shows a further schematic block diagram corresponding to the illustration in FIG. 1 with a modified switch arrangement.

FIG. 4 is a schematic block diagram of a device with two battery compartments and an alternative switch arrangement.

FIG. 5 is a schematic block diagram of a device with three battery compartments and three voltage regulators and a switch arrangement with switches in a first possible switching position.

FIG. 6 is a schematic block diagram according to FIG. 5 with a second possible switching position of the switches of the switch arrangement.

FIG. 7 is a schematic block diagram according to FIG. 5 with a third possible switching position of the switches of the switch arrangement.

FIG. 8 is a schematic block diagram of a device with four battery compartments and four voltage regulators and a switch arrangement with switches in a first possible switching position.

FIG. 9 is a schematic block diagram according to FIG. 8 with a second possible switching position of the switches of the switch arrangement.

FIG. 10 is a schematic block diagram according to FIG. 8 with a third possible switching position of the switches of the switch arrangement.

FIG. 11 is a schematic block diagram according to FIG. 8 with a fourth possible switching position of the switches of the switch arrangement.

### DETAILED DESCRIPTION

FIG. 1 shows a device 1 for charging battery packs. The device 1 has a first battery compartment 21 and a second battery compartment 22. A battery pack, not shown, which is to be charged by the device 1, is inserted into a battery compartment 21, 22. Different types of battery packs can be inserted into a battery compartment 21, 22. This may include battery packs with a charging capacity of 12 A, 24 A, 36 A or the like.

The device 1 is connected to a supply voltage U_{V} via a power supply unit 2. The supply voltage U_{V} can be a public power grid with a service voltage of, for example, 120V, 230 V or 400 VAC. The power supply may include a rectifier.

Voltage regulators 31, 32, which are connected to the power supply unit 2 on their respective input sides, are provided between the power supply 2 and a battery compartment 21, 22. The power output 41 of the voltage regulator 31 is selectively connected to electrical charging contacts in the battery compartment 21 via a first switch S1. Analogously, the power output 42 of the voltage regulator 32 is selectively electrically connected to electrical charging contacts in the battery compartment 22 via a second switch S2.

The voltage regulators 31 and 32 are located in line branches 41 and 42 that are electrically parallel to one another.

The first power output 41 of the first voltage regulator 31 and the second power output 42 of the second voltage regulator 32 can be selectively connected to one another by a third switch S3. The connection of the power outputs 41 and 42 by the third switch S3 lies between the line branch of the power output 41 from the voltage regulator 31 to the first switch S1 and the power branch of the power output 42 from the voltage regulator 32 to the second switch S2. In the direction of a charging current I₁ or I₂ flowing to the battery compartment 21, 22, the connection of the power outputs 41 and 42 is via the third switch S3 in front of the switches S1 and S2.

The voltage regulators 31 and 32 are preferably designed the same. In particular, the voltage regulators 31 and 32 may be step-down converters, and may be identical parts.

In the exemplary embodiment according to FIG. 1, the switches S1, S2 and S3 form a switch arrangement 5. The switches S1, S2 and S3 of the switch arrangement 5 are controlled by a control unit 10. For this purpose, the control unit 10 is connected to the individual switches S1, S2 and S3 via control lines 11, 12, 13. The switches S1, S2 and S3 may be solid state switches, or electromechanical relays.

When the switch S1 is closed, the first voltage regulator 31 supplies a first, in particular maximum, charging current I₁ to the battery compartment 21 via its power output 41. If the voltage regulator 31 provides a charging current of, for example, 12 A, a battery pack inserted into the battery compartment 21 is charged with 12 A.

When the switch S2 is closed, the second voltage regulator 32 supplies a second, in particular maximum, charging current I₂ to the battery compartment 22 via its power output 42. If the voltage regulator 32 provides a charging current of, for example, 12 A, a battery pack inserted into the battery compartment 22 is charged with 12 A.

The third switch S3 makes it possible to selectively connect the power outputs 41 and 42 of the voltage regulators 31 and 32 to one another and to supply them to only one battery compartment 21 and 22, respectively. For example, if the switch S1 and the switch S3 are closed, a charging current is supplied to the battery compartment 21, which is composed of the charging current I₁ of the voltage regulator 31 and the charging current I₂ of the voltage regulator 32. A battery pack inserted into the battery compartment 21 can be charged with an increased charging current I₁+I₂, for example twice 12 A, i.e. 24 A.

The control unit 10 communicates data with each battery compartment 21 or 22 via a communication connection 6 or 7. The communication connection 6 or 7 is designed in such a way that after inserting a battery pack into a battery compartment 21 or 22, a connection is established with the communication connection 6 or 7 and characteristic data of the battery pack are transmitted to the control unit 10. Characteristic data can be the nominal voltage of the battery pack, its capacity, its temperature, its chemical structure, its maximum charging current, or the like. By evaluating the characteristic data, the control unit 10 can determine whether a battery pack inserted, for example, into the battery compartment 21 can be charged with a simple charging current I₁ or with an increased charging current I₁+I₂.

If the battery pack inserted into the battery compartment 21 can only be charged with a maximum charging current I₁, only the switch S1 is closed.

If the control unit 10 determines that the battery pack inserted into the battery compartment 21 can be charged with a higher charging current, the switches S1 and S3 are closed, so that the power outputs 41 and 42 of the voltage regulators 31 and 32 are connected together and the increased charging current I₁+I₂ flows to the battery pack in the battery compartment 21 via the switch S1. The switch S2 of the other battery compartment 22 is then open. During the charging time of the battery pack in the first battery compartment 21 with increased charging current I₁+I₂, the battery compartment 22 is separated from the power outputs 41, 42. The battery compartment 22 is not available for charging a battery pack at that time.

It may be expedient to connect the control unit 10 to control inputs of the voltage regulators 31 and 32 via control lines 15 and 16. The control unit 10 can thus adapt the charging current I₁, I₂ and/or the charging voltage depending on the data received via the communication connection 6 or 7.

Without intervention by the user, a battery pack inserted into a battery compartment 21, 22 can be charged with a maximum charging current provided by the device, so that the charging time of a battery pack is significantly shortened. The control unit 10 of the device 1 independently recognizes which power class the inserted battery pack has and supplies the battery compartment with a maximum permissible charging current by actuating the switches S1, S2 and S3 of the switch arrangement 5. This permissible maximum charging current can be provided by a single voltage regulator 31, by two voltage regulators 31 and 32, or by more voltage regulators.

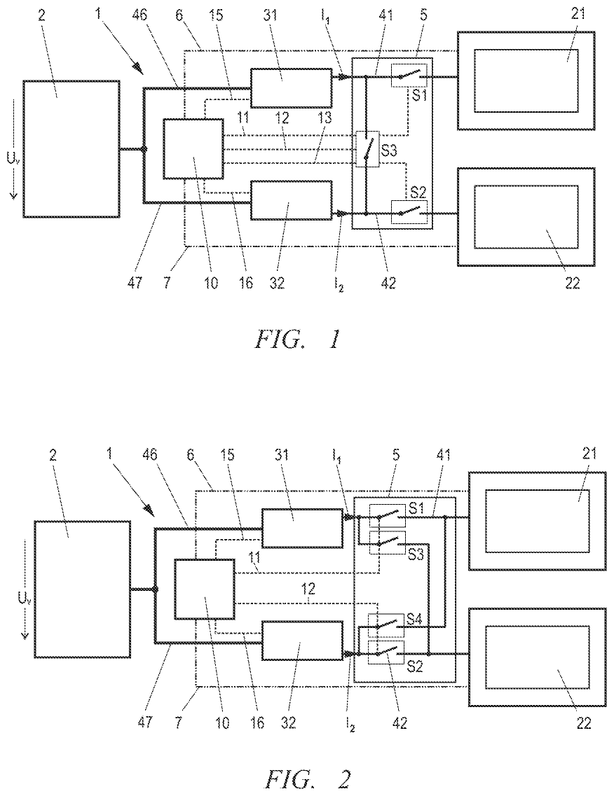

The voltage regulators 31 and 32, which are preferably designed as step-down converters, are advantageously designed as interchangeable parts. Each voltage regulator 31 or 32 in particular has the same maximum charging current. The switch arrangement 5 can be used to connect an integer multiple of the maximum charging current of a voltage regulator 31, 32 to a battery compartment 21 or 22. In the exemplary embodiment according to FIG. 2, two battery compartments and two voltage regulators are provided, so that twice the maximum charging current can be connected to one battery compartment.

In the exemplary embodiment according to FIG. 1, the switch arrangement consists of three switches S1, S2 and S3, with the switch S3 being arranged in front of the switches S1 and S2 in the flow direction of the charging current I₁ or I₂. In the exemplary embodiment according to FIG. 2, two switches S1/S3 or two switches S2/S4 are provided at each power output 41, 42. The switches S1 and S3 connect the power output 41 of the first voltage regulator 32 with a battery compartment 21, 22 each. The switches S2 and S4 respectively connect the power output 42 of the second voltage regulator 32 to the battery compartment 22 and 21. The switches S3 and S4 serve to connect the power outputs 41 and 42 to one another.

FIG. 2 shows a device, the switch arrangement 5 of which has a modified structure compared to FIG. 1. The exemplary embodiments according to FIGS. 1 and 2 correspond in structure; the same reference numbers are used for the same parts. The switch arrangement 5 in FIG. 2 consists of four switches S1, S2, S3 and S4, which are actuated according to the description of FIG. 1 by the control unit 10 depending on the characteristics of a battery pack inserted into a receiving slot 21 or 22. If a battery pack with low charging power is inserted into the battery compartment 21, the control unit 10 will only close the switch S1, so that a simple charging current I₁ flows to the battery compartment 21. Parallel to a charging process in the battery compartment 21, a battery pack can be charged in the battery compartment 22, to which a simple charging current I₂ from the voltage regulator 32 flows after the switch S2 is closed.

If a battery pack of higher capacity, which can be charged with a higher charging current, is inserted into a battery compartment 21 or 22, this is communicated to the control unit 10 by reading out the characteristics of the battery pack via the communication connection 6 or 7. If the battery pack with the higher charging power potential is inserted into the battery compartment 21, the control unit 10 will close the switch S1 and S4. A charging current I₁+I₂ flows to the battery compartment 21. The switches S2 and S3 are open; the battery compartment 22 is not available for charging.

However, if a battery pack with a higher charging power potential is inserted into the battery compartment 22, the control unit 10 will keep the switches S1 and S4 open and close the switches S2 and S3, so that an increased charging current I₁+I₂ flows to the battery compartment 22. The switches S1 and S4 are open; the battery compartment 21 is not available for charging.

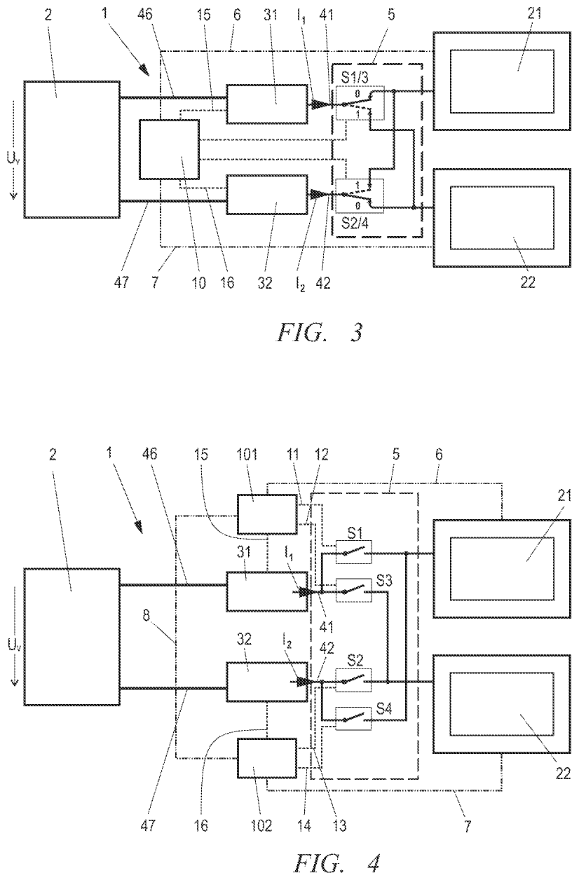

FIG. 3 shows a device according to the invention, the switch arrangement 5 of which has a modified structure compared to FIGS. 1 and 2. The exemplary embodiments according to FIGS. 1 to 3 correspond in structure; the same reference numbers are used for the same parts.

In the exemplary embodiment according to FIG. 3, the switch arrangement 5 consists of two switches, which are designed as changeover switches S1/3 and S2/4. The changeover switch S1/3 corresponds to the switches S1 and S3 in FIG. 2 or FIG. 1. The changeover switch S2/4 corresponds to the switches S2 and S4 in FIG. 2. The changeover switches S1/3 and S2/4 are controlled via the control unit 10 in accordance with the functional description for FIGS. 1 and 2.

A simple charging current I₁ or I₂ is supplied to the battery compartment 21 and the battery compartment 22 when the changeover switches 1/3 and 2/4 are in the “0” position.

If the changeover switch 1/3 is in the “1” position and the changeover switch 2/4 is in the “0” position, the two power outputs 41 and 42 are switched to the battery compartment 22 and an increased charging current I₁+I₂ flows into the battery compartment 22. If the changeover switch 1/3 is in the “0” position and the changeover switch 2/4 is in the “1” position, the two power outputs 41 and 42 are switched to the battery compartment 21 and an increased charging current I₁+I₂ flows into the battery compartment 21.

The exemplary embodiment according to FIG. 4 corresponds in its basic circuit structure to the exemplary embodiment according to FIG. 2. The same parts are given the same reference numbers.

While in FIG. 2 a central control unit 10 is provided for switching the switches S1, S2, S3, in the exemplary embodiment according to FIG. 4 each voltage regulator 31 or 32 is assigned a microprocessor as a control unit 101, 102. The control unit 101 is connected to a switch S1 or S3 via control lines 11, 12 and to the associated voltage regulator 31 via a control line 15. The control unit 102 is connected to the switches S2 and S4 via the control lines 13, 14 and to the associated voltage regulator 32 via a control line 16.

The control unit 101 is in data-transmitting connection with the battery compartment 21 via the communication connection 6 and the control unit 102 is in data-transmitting connection with the battery compartment 22 via the communication connection 7. The control units 101 and 102 are in data-transmitting connection with one another via a further communication connection 8. The communication connections 6, 7 and 8 can be designed as a bus.

The function of the device according to FIG. 4 corresponds to that according to FIGS. 1 to 3. The control units 101 and 102 compare the data received via the communication connections 6 and 7 from the battery pack inserted into a battery compartment with one another in order to then jointly control the switches S1, S3, S2, S4. According to the control of the switches S1, S3, S2, S4, each battery compartment 21 or 22 will receive a low charging current I₁ or I₂ or a single battery compartment 21 or 22 will receive a double charging current I₁+I₂.

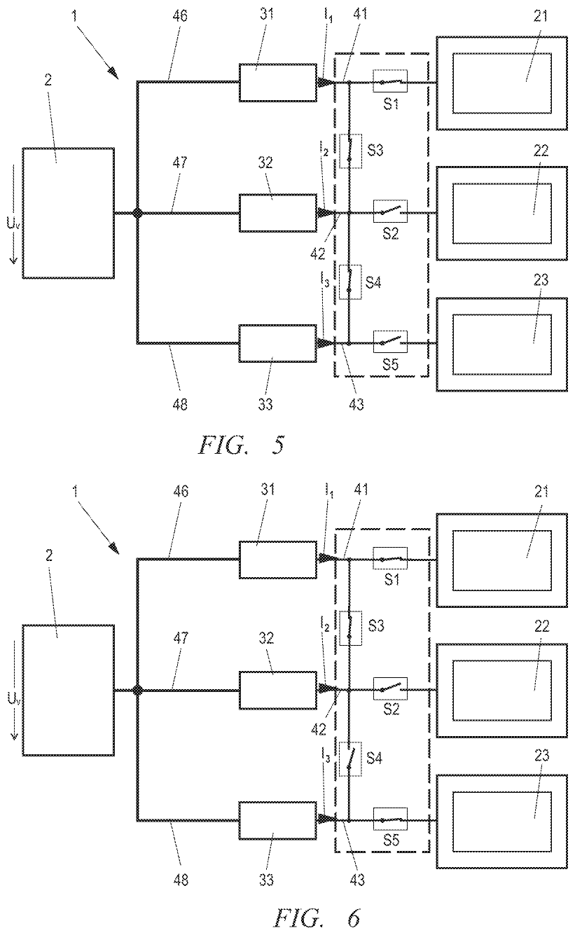

The exemplary embodiments according to FIGS. 5 to 11 represent an extended version of a device for charging battery packs similar to that shown in FIGS. 1 to 4. The same parts are given the same reference numbers. The explanations made about the structure of the device and its function in FIGS. 1 to 4 apply accordingly to FIGS. 5 to 11.

FIGS. 5 to 7 show a device 1 with three battery compartments 21, 22 and 23. Each battery compartment 21, 22 and 23 is connected to a power output 41, 42 and 43 of a voltage regulator 31, 32 and 33. A voltage regulator 31, 32 and 33 is therefore assigned to each battery compartment 21, 22 and 23. The voltage regulators 31, 32 and 33 are connected to a common power supply 2 on their input sides. The power outputs 41, 42 and 43 of the voltage regulators 31, 32 and 33 are each connected to the associated battery compartment 21, 22 and 23 via switches S1, S2 and S5. The power outputs 41 and 42 of the voltage regulators 31 and 32 are connected to one another via a switch S3. The power outputs 42 and 43 of the voltage regulators 32 and 33 are connected to one another via a switch S4. The switch arrangement 5 shown in FIG. 5 thus has five switches S1, S2, S3, S4 and S5. The switches S1, S2, S3, S4, and S5 are controlled via a control unit 10 or 101 or 102, as described in the previous exemplary embodiments of FIGS. 1 to 4.

In FIG. 5, the switches S2 and S5 are open and the switches S1, S3 and S4 are closed. The charging currents of the voltage regulators 31, 32 and 33 flow together via the switch S1 to the battery compartment 21. A charging current, which is composed of the charging currents I₁, I₂ and 1₃, thus flows to the battery compartment 21. If the voltage regulators 31, 32 and 33 have the same maximum charging current of, for example, 12 A, a battery pack can be charged in the battery compartment 21 with a charging current of 36 A. No charging current flows to the battery compartments 22 and 23 due to the open switches S2 and S5. No battery can be charged in the battery compartments 22 and 23 in the switching position of the switch arrangement according to FIG. 5.

The exemplary embodiment according to FIG. 6 corresponds in structure to that of FIG. 5. In contrast to FIG. 5, the switches S4 and S5 of the switch arrangement 5 have other positions. The switches S1, S3 and S5 of the switch arrangement 5 are closed and the switches S2 and S6 are open. An increased charging current of I₁+I₂ flows to the battery compartment 21. A simple charging current I₃ flows to the battery compartment 23. The battery compartment 22 is out of operation due to the open switch S2. If the voltage regulators 31, 32 and 33, which are preferably of the same design with a maximum charging current of, for example, 12 A, the battery compartment 21 would have a charging current of 24 A and the battery compartment 23 would have a charging current of 12 A.

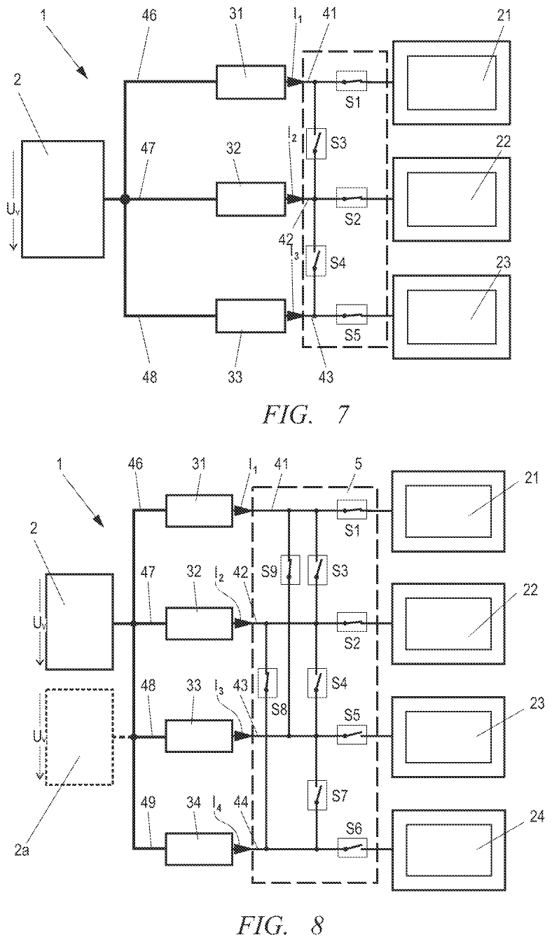

FIG. 7 shows a structure of the device according to the invention according to FIGS. 5 and 6 with a switch arrangement with switches S1, S2, S3, S4 and S5 in changed switching positions. The switches S3 and S4 connecting the power outputs 41, 42 and 43 are open and the switches S1, S2 and S5 are closed. Each battery compartment 21, 22 and 23 is therefore connected to only one power output 41, 42 and 43, respectively. The charging current I₁ flows to the battery compartment 21, the charging current I₂ flows to the battery compartment 22 and the charging current I₃ flows to the battery compartment 23. If the voltage regulators 31, 32, 33 have a maximum charging current of advantageously 12 A each, a charging current of 12 A flows to each battery compartment 21, 22, 23. In all three battery compartments 21, 22, 23, one battery pack can each be charged at the same time with a maximum charging current of 12 A.

The exemplary embodiments according to FIGS. 8 to 11 show a device 1 for charging a battery pack with four battery compartments 21, 22, 23 and 24. Each battery compartment 21, 22, 23, 24 is connected to a voltage regulator 31, 32, 33, 34. A voltage regulator 31, 32, 33, 34 is therefore assigned to each battery compartment 21, 22, 23, 24. The power outputs 41, 42, 43, 44 of the voltage regulators 31, 32, 33, 34 are each connected to a battery compartment 21, 22, 23, 24 via a respective switch S1, S2, S5, S6.

On the input side, the voltage regulators 31, 32, 33 and 34 are connected to a supply network via a power supply 2. It may be expedient to provide a second power supply 2a on the input side, which is connected in parallel to the first power supply on the input side of the voltage regulators 31, 32, 33 and 34.

In addition, adjacent power outputs 41 and 42, 42 and 43 as well as 43 and 44 are each connected to one another via switches S3, S4 and S7. The next but one power outputs are connected to one another via switches S8 and S9. In the exemplary embodiment shown, the power output 41 is connected to the power output 43 via the switch S9 and the power output 42 is connected to the power output 44 via the switch S8.

The switch arrangement 5 therefore consists of nine switches S1, S2, S3, S4, S5, S6, S7, S8 and S9. The switches S1, S2, S3, S4, S5, S6, S7, S8 and S9 of the switch arrangement 5 are controlled via a control unit 10 or 101, 102, as described for FIGS. 1 to 4.

In FIG. 8, the switches S1, S2, S8 and S9 are closed. The switches S3, S4, S5, S6 and S7 are open. The charging currents I₁ and 1₃ of the power outputs 41 and 43 flow to the battery compartment 21 via the closed switches S1 and S9. The charging currents I₂ and 1₄ of the power outputs 42 and 44 flow to the battery compartment 22 via the closed switch S2 and S8. If the voltage regulators 31, 32, 33, 34 provide a maximum charging current of advantageously 12 A each, a charging current of 24 A flows to each the battery compartment 21 and the battery compartment 22.

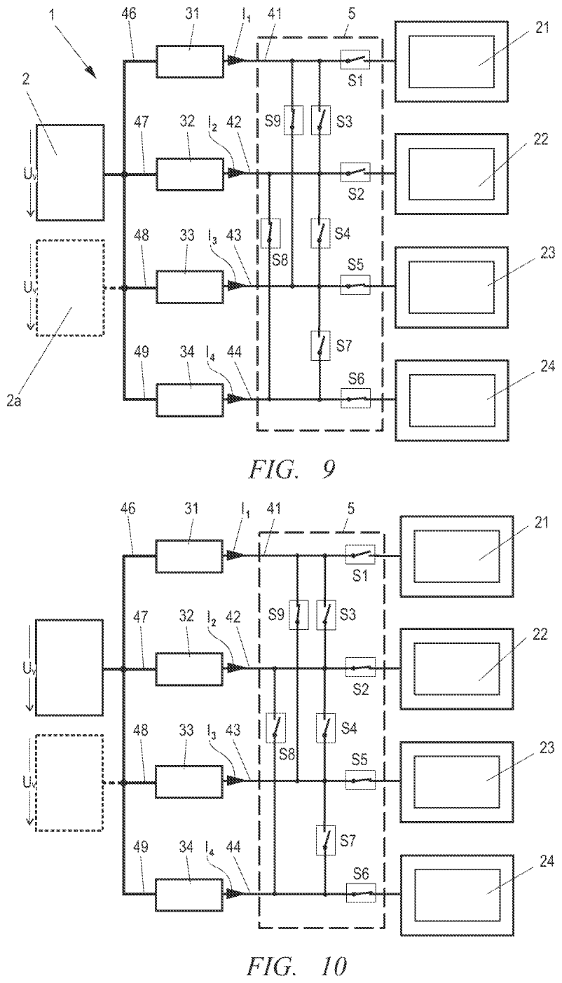

The structure of the device according to FIG. 9 corresponds to the structure of the device according to FIG. 8. In FIG. 9, the switches S1, S2, S3, S4, S5, S6, S7, S8 and S9 of the switch arrangement 5 have other switching positions. The switches S5, S6, S8 and S9 are closed. The switches S1, S2, S3, S4 and S7 are open. The charging currents I₁ and 1₃ of the power outputs 41 and 43 flow to the battery compartment 23 via the closed switches S5 and S9. The charging currents I₂ and 1₄ of the power outputs 42 and 44 flow to the battery compartment 24 via the closed switches S6 and S8. If the voltage regulators 31, 32, 33, 34 provide a maximum charging current of advantageously 12 A each, a charging current of 24 A flows to each the battery compartment 23 and the battery compartment 24. A battery pack with 24 A can be charged at the same time in the battery compartments 23 and 24. The battery compartments 21 and 22 are out of operation during the charging process of the battery compartments 23 and 24 due to the open switches S1 and S2.

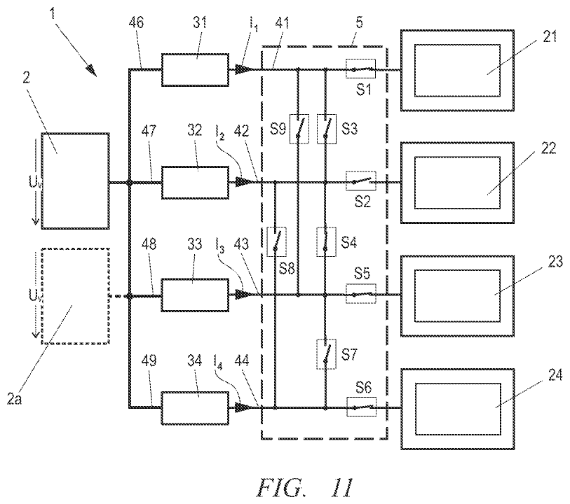

FIG. 10 shows a further mode of operation of the device according to FIGS. 8 and 9. FIG. 10 differs from FIGS. 8 and 9 in the switching positions of the switches S1, S2, S3, S4, S5, S6, S7, S8 and S9 of the switch arrangement 5.

As shown in FIG. 10, the switches S2, S5, S6 and S9 are closed. The switches S1, S3, S4, S7, S8 are in their open switching position.

The switch S1 of the battery compartment 21 is open; therefore the battery compartment 21 is out of operation.

The battery compartment 22 is connected to the power output 42 of the voltage regulator 32 via the closed switch S2. The charging current I₂ flows to the battery compartment 22.

The battery compartment 23 is connected to the power output 43 of the voltage regulator 33 via the closed switch S5 and to the power output 41 of the voltage regulator 31 via the closed switch S9. The charging current I₁+I₃ flows to the battery compartment 23.

The battery compartment 24 is connected to the voltage regulator 34 via the closed switch S6. The charging current I₄ flows to the battery compartment 24.

If the voltage regulators 31, 32, 33, 34 provide the same maximum charging current of advantageously 12 A each, a charging current I₂ of 12 A flows into the battery compartment 22. A charging current I₁+I₃ of 24 A flows to the battery compartment 23. A charging current I₄ of 12 A flows to the battery compartment 24.

The exemplary embodiment according to FIG. 11 corresponds in its structure and functionality to those according to FIGS. 8 to 10. The same parts are given the same reference numbers. The switches S1, S2, S3, S4, S5, S6, S7, S8 and S9 of the switch arrangement 5 are in different switching positions compared to FIGS. 8 to 10. The switches S1, S4, S5 and S6 are closed. The switches S2, S3, S7, S8 and S9 are in their open switching position.

The battery compartment 21 is connected to the power output 41 of the voltage regulator 31 via the closed switch S1. The charging current I₁ flows to the battery compartment 21.

The switch S2 of the battery compartment 22 is open; therefore the battery compartment 22 is out of operation.

The battery compartment 23 is connected to the power output 43 of the voltage regulator 33 via the closed switch S5 and to the power output 42 of the voltage regulator 32 via the closed switch S4. The charging current I₂+I₃ flows to the battery compartment 23.

The battery compartment 24 is connected to the voltage regulator 34 via the closed switch 6. The charging current I₄ flows to the battery compartment 24.

If the voltage regulators 31, 32, 33, 34 have the same maximum charging current of advantageously 12 A each, a charging current I₂ of 12 A flows into the battery compartment 21. A charging current I₂+I₃ of 24 A flows to the battery compartment 23. A charging current I₄ of 12 A flows to the battery compartment 24.

As the various exemplary embodiments show, the structure of the device for charging a battery pack enables a high degree of flexibility when charging battery packs of different capacities and/or different maximum charging currents. An advantage here is that the voltage regulators designed as step-down converters have the same design with the same performance data. Through the switch arrangement 5 and the control unit 10, 101, 102 controlling the switches of the switch arrangement 5, a battery compartment 21, 22, 23, 24 can be supplied with an integer multiple (1×, 2×, 3×, or 4×) of the maximum charging current of a voltage regulator 31, 32, 33, 34. Since the device 1 independently recognizes and evaluates the type and performance data of a battery pack inserted into a battery compartment 21, 22, 23, 24, the user has a charging option for battery packs of different types at his disposal without requiring any special knowledge or special skills when using battery packs.

What is claimed is:

1. A device for charging a battery pack, comprising:
a first battery compartment (21) for accommodating a first battery pack;
a second battery compartment (22) for accommodating a second battery pack;
a power supply (2) for connecting the device (1) to a service voltage (U_{V});
a first voltage regulator (31) having a first power output (41) for providing a first maximum charging current (I₁);
a second voltage regulator (32) having a second power output (42) for providing a second maximum charging current (I₂);
a switch arrangement (5) configured to selectively,
connect the first battery compartment (21) to only the first power output (41) or
connect the first battery compartment (21) to both the first power output (41) and the second power output (42).

2. The device according to claim 1,
wherein the switch arrangement (5) comprises a plurality of switches (S1, S2, S3).

3. The device according to claim 2,
wherein the switch arrangement (5) comprises
a first switch (S1) that selectively connects the first power output (41) to the first battery compartment (21), and
a second switch (S2) that selectively connects the second power output (42) to the second battery compartment (22), and
a third switch (S3) that selectively connects the first power output (41) to the second power output (42).

4. The device according to claim 1,
wherein the switch arrangement (5) comprises a plurality of switches (S1, S2, S3), and
wherein the switch arrangement (5) is connected to a control unit (10), the control unit (10) being configured to control the plurality of switches (S1, S2, S3) of the switch arrangement (5).

5. The device according to claim 1,
wherein the switch arrangement (5) comprises a plurality of switches (S1, S2, S3),
wherein the switch arrangement (5) is connected to a control unit (10),
wherein the control unit (10) is connected to the first battery compartment (21) and to the second battery compartment (22) via a communication connection (6, 7), and
wherein the communication connection (6, 7) is designed
to transmit characteristics of the first battery pack to the control unit (10) when the first battery pack is inserted into the first battery compartment (21, 22) and
to transmit characteristics of the second battery pack to the control unit (10) when the second battery pack is inserted into the second battery compartment (21, 22).

6. The device according to claim 5,
wherein the control unit (10) is designed to control the switches (S1, S2, S3) of the switch arrangement (5) depending on the characteristics received via the communication connection (6, 7) from the first battery pack or the second battery pack.

7. A device for charging battery packs, comprising:
a power supply for connecting the device to a service voltage;
a plurality of battery compartments; and
a plurality of voltage regulators, each of the plurality of voltage regulators being connected to the power supply and having a power output for providing a maximum charging current,
wherein each of the power outputs can be connected to a respective one of the plurality of battery compartments through a switch arrangement, and
wherein at least one of the plurality of battery compartments can be connected to more than one of the power outputs while another one of the plurality of battery compartments is not connected to any of the power outputs.

8. The device according to claim 7,
wherein the power outputs of at least two of the plurality of voltage regulators are selectively connected to one another via a switch of the switch arrangement.

9. The device according to claim 7,
wherein the voltage regulators of the device are of the same design.

10. The device according to claim 7,
wherein the maximum charging current of all voltage regulators of the device is the same.

11. The device according to claim 7,
wherein the voltage regulators are arranged in line branches that are electrically parallel to one another.

12. The device according to claim 7,
wherein the voltage regulators are step-down converters.
